(19) United States
(12) Patent Application Publication
(10) Pub. No.: US 2020/0291903 A1
(43) Pub. Date: Sep. 17, 2020

(54) CANISTER

(71) Applicant: FUTABA INDUSTRIAL CO., LTD., Okazaki-shi (JP)

(72) Inventors: Takuya Nakagawa, Okazaki-shi (JP); Makoto Kato, Okazaki-shi (JP); Masahito Hosoi, Okazaki-shi (JP)

(21) Appl. No.: 16/810,336

(22) Filed: Mar. 5, 2020

(30) Foreign Application Priority Data
Mar. 15, 2019 (JP) 2019-048511

(51) Int. Cl. F02M 25/08; B67D 7/04

(52) U.S. Cl. CPC F02M 25/0854; B01D 2253/102; B67D 7/0478; F02M 25/089

(57) ABSTRACT

A canister includes a main chamber where a charge port and a purge port are located, and at least one subsidiary chamber. Any one of the at least one subsidiary chamber includes an atmosphere port. The at least one subsidiary chamber includes at least one specified subsidiary chamber including a specified absorption layer containing specified activated carbon. An L/D of the specified absorption layer is equal to or greater than 2.0 and equal to or less than 7.0 where L is a length of the specified absorption layer and D is an equivalent diameter of a cross-section of the specified absorption layer taken orthogonally to longitudinal directions. The specified activated carbon has BWC equal to or greater than 8.0 g/dL and equal to or less than 10.5 g/dL.

### CROSS-REFERENCE TO RELATED APPLICATIONS

This application claims the benefit of Japanese Patent Application No. 2019-048511 filed on Mar. 15, 2019 with the Japan Patent Office, the entire disclosure of which is incorporated herein by reference.

### BACKGROUND

The present disclosure relates to a canister.

A vehicle is equipped with a canister for inhibiting an evaporated fuel in a fuel tank from being discharged into the atmosphere. Such a canister draws the evaporated fuel from the fuel tank via a charge port, and absorbs the evaporated fuel using activated carbon. The evaporated fuel absorbed by the activated carbon in the canister is then discharged into an engine by purging. More specifically, the canister draws the atmosphere through an atmosphere port by a negative intake air pressure; allows the evaporated fuel absorbed by the activated carbon to be desorbed; and supplies the engine with the desorbed evaporated fuel through the purge port.

The canister comprises a main chamber including the charge port and the purge port, and at least one subsidiary chamber coupled to the main chamber. The at least one subsidiary chamber includes a subsidiary chamber that comprises the atmosphere port. Each of these chambers includes activated carbon for absorbing the evaporated fuel. To adjust a capacity to absorb/desorb the fuel, each chamber is designed to have an appropriately determined ratio (L/D) of a length (L) in flowing directions of a gas to an equivalent diameter (D) of a cross-section taken orthogonally to the flowing directions (see Japanese Unexamined Patent Application Publication No. 2012-007501).

### SUMMARY

A recent low emission vehicle such as a hybrid vehicle draws reduced amount of the atmosphere by purging, which causes insufficient desorption of a fuel by purging. As a result, such a vehicle (hereinafter referred to as low-purge vehicle) has an increased amount of evaporated fuel remained in a canister, and may easily discharge the evaporated fuel into the atmosphere through an atmosphere port.

One aspect of the present disclosure desirably reduces discharge of a fuel into the atmosphere in the low-purge vehicle.

One aspect of the present disclosure is a canister configured to accumulate an evaporated fuel generated in a fuel tank of a vehicle. The canister comprises a charge port, a purge port, an atmosphere port, a main chamber, and at least one subsidiary chamber. The charge port is configured to draw the evaporated fuel. The purge port is configured to discharge the evaporated fuel. The atmosphere port is open to atmosphere. The charge port and the purge port is located in the main chamber. A main absorption layer containing activated carbon is disposed in the main chamber. The at least one subsidiary chamber extends in longitudinal directions: the longitudinal directions include a first side and a second side. A subsidiary absorption layer containing activated carbon is disposed in the at least one subsidiary chamber. A first side end of the at least one subsidiary chamber is coupled to the main chamber or a second side end of a different subsidiary chamber included in the at least one subsidiary chamber. The at least one subsidiary chamber includes a subsidiary chamber, in a second side end of which the atmosphere port is located. The at least one subsidiary chamber includes at least one specified subsidiary chamber, in which the subsidiary absorption layer configured as a specified absorption layer is located. The ratio (L/D) of a length (L) of the specified absorption layer disposed in the at least one specified subsidiary chamber in the longitudinal directions to an equivalent diameter (D) of a cross-section of the specified absorption layer taken orthogonally to the longitudinal directions is equal to or greater than 2.0 and equal to or less than 7.0. The activated carbon included in the specified absorption layer is specified activated carbon having butane working capacity (BWC) equal to or greater than 8.0 g/dL and equal to or less than 10.5 g/dL, measured in accordance with D5228 of ASTM Standards.

According to the aforementioned configuration, the specified absorption layer in the specified subsidiary chamber includes the specified activated carbon, and therefore a capacity to absorb the fuel is improved. In addition, by setting the L/D of the specified absorption layer to equal to or greater than 2.0 and equal to or less than 7.0, a gas that flows down the specified subsidiary chamber efficiently contacts the specified absorption layer, which helps inhibit an increase in pressure loss. Thus, the absorbed fuel can be more efficiently removed in the specified absorption layer by purging, which can reduce remaining fuel. Therefore, discharge of the fuel to the atmosphere can be reduced in a low-purge vehicle.

In one aspect of the present disclosure, a honeycomb absorbent including the specified activated carbon may be located in the specified absorption layer. The honeycomb absorbent may be cylindrical and located in the at least one specified subsidiary chamber so as to extend in the longitudinal directions. The honeycomb absorbent may include flow passes passing through the honeycomb absorbent in the longitudinal directions.

In one aspect of the present disclosure, the specified absorption layer may include hollow activated carbon; each hollow activated carbon is a granular member containing the specified activated carbon. The hollow activated carbon may include at least one hole passing therethrough.

According to the aforementioned configuration, the pressure loss can be further reduced when the gas passes through the specified subsidiary chamber. Thus, the accumulated fuel in the canister can be more efficiently removed by purging and the fuel remaining in the canister can be reduced. Therefore, discharge of the fuel to the atmosphere can be reduced in the low-purge vehicle.

In one aspect of the present disclosure, the specified absorption layer may include at least one member containing the specified activated carbon. The at least one member may have an improved capacity to absorb the evaporated fuel and an improved capacity to desorb the evaporated fuel absorbed in the at least one member by disposing elongated vent holes.

According to the aforementioned configuration, the specified absorption layer improves the capacity to absorb the fuel as well as the capacity to desorb the absorbed fuel. Therefore, discharge of the fuel to the atmosphere can be reduced in the low-purge vehicle.

In one aspect of the present disclosure, a ratio of a volume of the main absorption layer of the main chamber to a volume of the specified absorption layer may be equal to or greater than 5.5 and equal to or less than 10.

According to the aforementioned configuration, an amount of fuel remaining in the specified subsidiary chamber after purging can be reduced while inhibiting an increase in the pressure loss. As a result, discharge of the fuel from the atmosphere port can be reduced.

In one aspect of the present disclosure, a ratio of a volume of the main absorption layer of the main chamber to a sum of volumes of the subsidiary absorption layers of all of the at least one subsidiary chamber may be equal to or greater than 5.5 and equal to or less than 10.

According to the aforementioned configuration, an amount of fuel remaining in the specified subsidiary chamber after purging can be reduced while inhibiting an increase in the pressure loss. As a result, discharge of the fuel from the atmosphere port can be reduced.

In one aspect of the present disclosure, the canister may further comprise a casing comprising the main chamber, and a subsidiary casing separated from the casing. The at least one subsidiary chamber includes a plurality of subsidiary chambers. One subsidiary chamber among the subsidiary chambers is located in the subsidiary casing and rest of the subsidiary chambers are located in the casing. A first side end of the subsidiary chamber in the subsidiary casing may be coupled to a second side end of one of the rest of the subsidiary chambers in the casing via a hose. The atmosphere port may be provided at a second side end of the subsidiary chamber in the subsidiary casing.

According to the aforementioned configuration, the subsidiary chamber provided with the atmosphere port is separated from the casing where the main chamber and the at least one subsidiary chamber are provided. This enables the canister to be installed in the vehicle in various forms.

### BRIEF DESCRIPTION OF THE DRAWINGS

An example embodiment of the present disclosure will be described hereinafter with reference to the accompanying drawings, in which:

FIG. 1 is an explanatory diagram showing a transparent view of a canister of a first embodiment where a first subsidiary chamber is configured as a specified subsidiary chamber;

FIG. 2 is an explanatory diagram showing a transparent view of the canister of the first embodiment where a second subsidiary chamber is configured as the specified subsidiary chamber.

FIG. 3 is an explanatory diagram showing a transparent view of the canister of the first embodiment where the first and the second subsidiary chambers are configured as the specified subsidiary chambers;

FIG. 4 is a perspective view of a honeycomb absorbent;

FIG. 5 is an explanatory diagram showing vent holes formed on the honeycomb absorbent;

FIG. 6 is a perspective view showing hollow activated carbon;

FIG. 7 is a perspective view showing granular activated carbon; and

FIG. 8 is an explanatory diagram showing a canister of a second embodiment.

### DETAILED DESCRIPTION OF EXEMPLARY EMBODIMENTS

The present disclosure is not limited to the embodiments explained hereinafter and may be modified in various modes within the technical scope of the present disclosure.

### Embodiment 1

### [1. Outline]

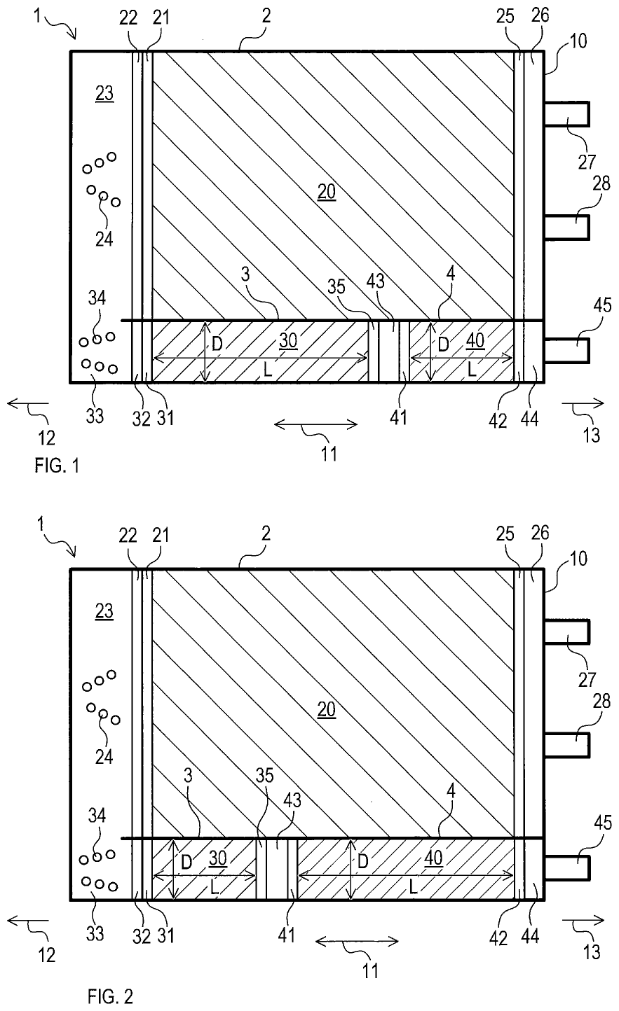

In FIG. 1 to FIG. 3, a canister 1 of a first embodiment is shown. The canister 1 is installed in a vehicle and is configured to accumulate an evaporated fuel generated in a fuel tank of the vehicle. The canister 1 comprises a casing 10, a main chamber 2, a first subsidiary chamber 3, a second subsidiary chamber 4, a charge port 27, a purge port 28, an atmosphere port 45, a main absorption layer 20, a first subsidiary absorption layer 30, and a second subsidiary absorption layer 40; each absorption layer includes activated carbon.

The casing 10 is made of materials such as a synthetic resin. The casing 10 houses the main chamber 2, the first subsidiary chamber 3, and the second subsidiary chamber 4. Hereinafter, one side of each chamber along longitudinal directions 11 (in other words, flowing directions of a fluid) is a first side 12; and the other side is a second side 13.

The charge port 27 is coupled to the fuel tank of the vehicle via a tube. The charge port 27 draws the evaporated fuel generated in the fuel tank into the casing 10.

The purge port 28 is coupled to an inlet pipe of an engine of the vehicle via a purge valve. The purge port 28 discharges the evaporated fuel accumulated inside the casing 10 and supplies the engine with the discharged evaporated fuel.

The atmosphere port 45 is coupled to a fuel inlet of the vehicle via a tube, and is open to the atmosphere. The atmosphere port 45 discharges a gas removed of the evaporated fuel to the atmosphere. The atmosphere port 45 draws the atmosphere (in other words, purge air) and thereby desorbs (hereinafter, purges) the evaporated fuel accumulated in the casing 10. Thus purged evaporated fuel is discharged through the purge port 28.

The main absorption layer 20 is located in the main chamber 2. The main absorption layer 20 is filled with absorbent materials including the activated carbon. An air permeable resin plate 22 and a filter 21 are stacked adjacent to the main absorption layer 20 on the first side 12; a filter 25 is stacked adjacent to the main absorption layer 20 on the second side 13. A space 23 is provided at a first side end of the main chamber 2 located on the first side 12. The space 23 communicates the main absorption layer 20 with the first subsidiary chamber 3. The space 23 includes a spring 24 configured to press the resin plate 22 and the filter 21 towards the second side 13. The charge port 27 and the purge port 28 are located at a second side end of the main chamber 2 located on the second side 13. A space 26 is provided between these ports 27, 28 and the filter 25.

The first subsidiary chamber 3 and the second subsidiary chamber 4 are located adjacent to the main chamber 2 and arranged side by side along the longitudinal directions 11. The first subsidiary absorption layer 30 is located in the first subsidiary chamber 3; and the second subsidiary absorption layer 40 is located in the second subsidiary chamber 4. The first subsidiary chamber 3 and the second subsidiary chamber 4 are configured to communicate with the main chamber 2 to let the gas flow. The first subsidiary absorption layer 30 and the second subsidiary absorption layer 40 are filled with absorbent materials including the activated carbon.

The first subsidiary absorption layer 30 is located in the first subsidiary chamber 3. A resin plate 32 and a filter 31, similar to the aforementioned resin plate 22 and filter 21, are stacked adjacent to the first subsidiary absorption layer 30 on the first side 12. A filter 35 is stacked adjacent to the first subsidiary absorption layer 30 on the second side 13. A space 33 is provided at a first side end of the first subsidiary chamber 3 on the first side 12. The space 33 communicates the first subsidiary chamber 3 with the main chamber 2. In other words, the first side end of the first subsidiary chamber 3 is coupled to the first side end of the main chamber 2. The space 33 includes a spring 34 configured to press the resin plate 32 and the filter 31 towards the second side 13.

The second subsidiary absorption layer 40 is located in the second subsidiary chamber 4. A filter 41 is stacked adjacent to the second subsidiary absorption layer 40 on the first side 12; a filter 42 is stacked adjacent to the second subsidiary absorption layer 40 on the second side 13. A space 43 is provided at a first side end of the second subsidiary chamber 4 on the first side 12. The space 43 communicates the second subsidiary chamber 4 with the first subsidiary chamber 3. In other words, the first side end of the second subsidiary chamber 4 is coupled to the second side end of the first subsidiary chamber 3 on the second side 13. The atmosphere port 45 is located at a second side end of the second subsidiary chamber 4 on the second side 13. A space 44 is provided between the atmosphere port 45 and the filter 42.

The evaporated fuel drawn through the charge port 27 enters the main chamber 2 and is absorbed by the main absorption layer 20. An excess of the evaporated fuel that is not absorbed by the main absorption layer 20 enters the first subsidiary chamber 3 through the space 23, and absorbed by the first subsidiary absorption layer 30. A further excess of the evaporated fuel that is not absorbed by the first subsidiary absorption layer 30 enters the second subsidiary chamber 4 and absorbed by the second subsidiary absorption layer 40. The gas removed of the evaporated fuel is discharged through the atmosphere port 45.

The purge air is drawn through the atmosphere port 45 by a negative intake air pressure in the engine. The purge air sequentially enters the second subsidiary chamber 4, the first subsidiary chamber 3, and the main chamber 2 in this order, and removes the fuel absorbed in the absorption layer of each chamber. The removed fuel is discharged with the purge air through the purge port 28 and supplied to the engine.

### [2. Specified Subsidiary Chamber]

At least one of the first subsidiary chamber 3 or the second subsidiary chamber 4 in the canister 1 is configured as a specified subsidiary chamber (see FIG. 1 to FIG. 3). A ratio (L/D) of a length (L) of the subsidiary absorption layer disposed in the specified subsidiary chamber in the longitudinal directions 11 to an equivalent diameter (D) of a cross-section of the subsidiary absorption layer taken orthogonally to the longitudinal directions 11 is equal to or greater than 2.0 and equal to or less than 7.0. The equivalent diameter is a value of a diameter of a true circle (D=(S/π)^{1/2}×2) which has an area S that is the same as an area of the cross-section taken orthogonally to the longitudinal directions 11, averaged by the length L in the longitudinal directions 11.

The activated carbon included in the subsidiary absorption layer of the specified subsidiary chamber (hereinafter referred to as specified absorption layer) is specified activated carbon that has butane working capacity (BWC) equal to or greater than 8.0 g/dL and equal to or less than 10.5 g/dL, measured in accordance with D5228 of ASTM Standards.

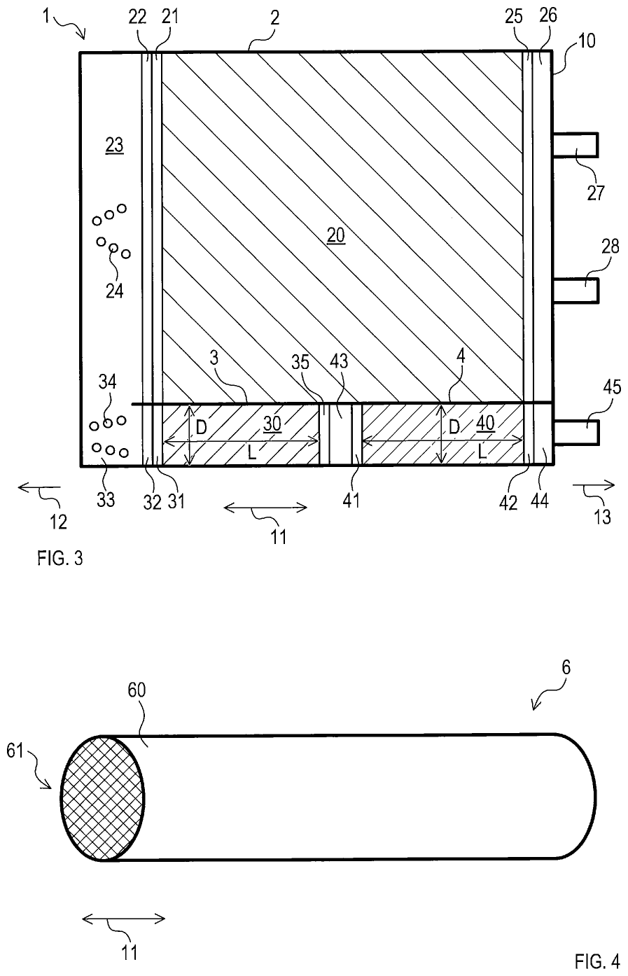

As shown in FIG. 1, the first subsidiary chamber 3 may be configured as the specified subsidiary chamber. Nevertheless, the second subsidiary chamber 4 may be configured as the specified subsidiary chamber (see FIG. 2) or all of the subsidiary chambers (the first subsidiary chamber 3 and the second subsidiary chamber 4) may be configured as the specified subsidiary chambers (see FIG. 3).

A honeycomb absorbent 6 that includes the specified activated carbon may be located in the specified absorption layer (see FIG. 4). The honeycomb absorbent 6 has a cylindrical side wall 60 and is located in the specified subsidiary chamber so as to extend in the longitudinal directions 11. A diameter of a cross-section of the side wall 60 taken orthogonally to the longitudinal directions 11, may be from 29 mm to 45 mm for example. The honeycomb absorbent 6 also has wall members arranged in grid patterns inside of the side wall 60. Spaces between these wall members form flow passes 61 passing through the honeycomb absorbent 6 in the longitudinal directions 11. Each of the flow passes 61 linearly extends in the longitudinal directions 11. The honeycomb absorbent 6 is formed by fixing the specified activated carbon with a binder.

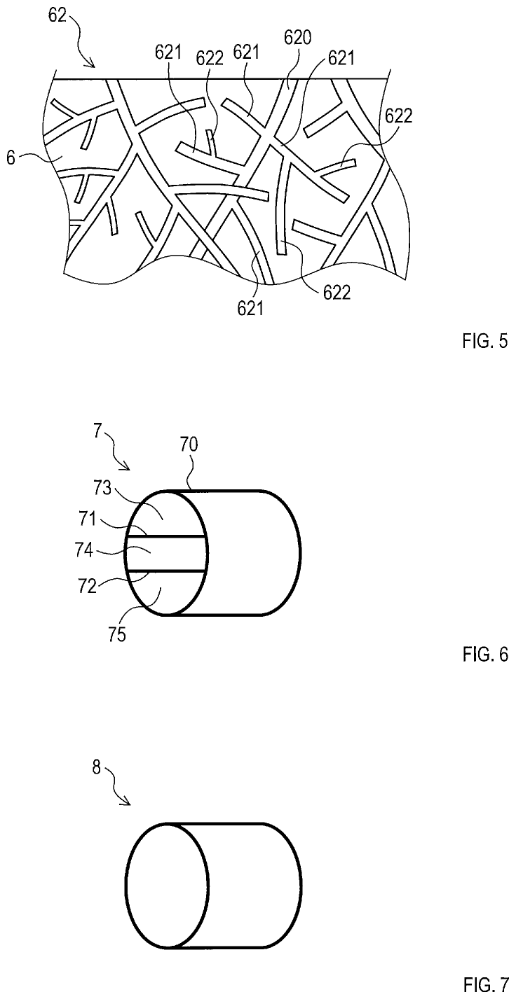

The honeycomb absorbent 6 includes elongated vent holes 62 formed inside the honeycomb absorbent 6 (see FIG. 5). This improves a capacity to absorb the evaporated fuel and a capacity to desorb the absorbed evaporated fuel. The vent holes 62 include at least main vent holes 620 extending from a surface of the honeycomb absorbent 6; first branch holes 621 branching from the main vent holes 620; and second branch holes 622 branching further from the first branch holes 621. There may be further vent holes branching from the second branch holes 622. These vent holes 62 are created by first forming the honeycomb absorbent 6 using the specified activated carbon and the binder mixed with additives, and then removing the additives by a chemical agent and the like. Details about the vent holes should be found in Japanese Unexamined Patent Application Publication No. 2010-001862.

The specified absorption layer may also be filled with granular hollow activated carbon 7 (see FIG. 6) containing the specified activated carbon. Each hollow activated carbon 7 includes holes 73 to 75 passing through the hollow activated carbon 7. More specifically, the hollow activated carbon 7 includes a cylindrical outer wall 70. A cross sectional diameter of the outer wall 70 may be, for example, 3 mm to 5 mm. The hollow activated carbon 7 includes two inner walls 71, 72 inside the outer wall 70. The inner walls 71, 72 are disposed transversely in an inner space of the outer wall 70 and arranged approximately parallel with each other interposing a center axis of the cylindrical outer wall 70. Ends of the inner walls 71, 72 are connected to an inner circumferential surface of the outer wall 70. Clearances formed by the outer wall 70 and the inner walls 71, 72 provide the holes 73 to 75. The shape of the hollow activated carbon 7 and the number of holes that pass through the hollow activated carbon 7 should not be limited and may be determined appropriately.

The specified absorption layer may also be filled with granular activated carbon 8 (see FIG. 7). Each granular activated carbon 8 is formed into a columnar shape. A cross sectional diameter of the granular activated carbon 8 may be, for example, 3 mm to 5 mm.

Likewise with the honeycomb absorbent 6, the hollow activated carbon 7 and the granular activated carbon 8 are created by fixing the specified activated carbon with the binder. The hollow activated carbon 7 and the granular activated carbon 8 also include the vent holes 62 similar to those included in the honeycomb absorbent 6. This improves the capacity to absorb the evaporated fuel and the capacity to desorb the absorbed evaporated fuel.

The hollow activated carbon 7 and the granular activated carbon 8 fill the specified absorption layer unaligned, without adjustment of orientation. The shapes and the like of the hollow activated carbon 7 and granular activated carbon 8 should not be limited and may be determined appropriately.

The honeycomb absorbent 6, the hollow activated carbon 7, or the granular activated carbon 8 arranged in the specified absorption layer does not have to include the aforementioned vent holes 62.

### [3. Volume Ratio]

In the first embodiment, a ratio of a volume of the main absorption layer 20 of the main chamber 2 to a volume of the specified absorption layer is equal to or greater than 5.5 and equal to or less than 10 (see FIG. 1, 2).

The volume of the main absorption layer 20 is M, and the volume of the specified absorption layer is X0. In other words, the volume ratio is M/X0. In addition, a ratio of the volume of the main absorption layer 20 to a sum of volumes (X1) of all the subsidiary absorption layers in all the subsidiary chambers (the first subsidiary absorption layer 30 of the subsidiary chamber 3 and the second subsidiary absorption layer 40 of the subsidiary chamber 4) in the canister 1 may be equal to or greater than 5.5 and equal to or less than 10 (see FIG. 3). In other words, the volume ratio is M/X1. If there are two or more specified subsidiary chambers, a ratio of a volume of the main absorption layer 20 of the main chamber 2 to a sum of volumes (X2) of all the specified absorption layers of all the specified subsidiary chambers may be equal to or greater than 5.5 and equal to or less than 10. In other words, the volume ratio is M/X2. These volume ratios may also have different values.

### Embodiment 2

### [4. Outline]

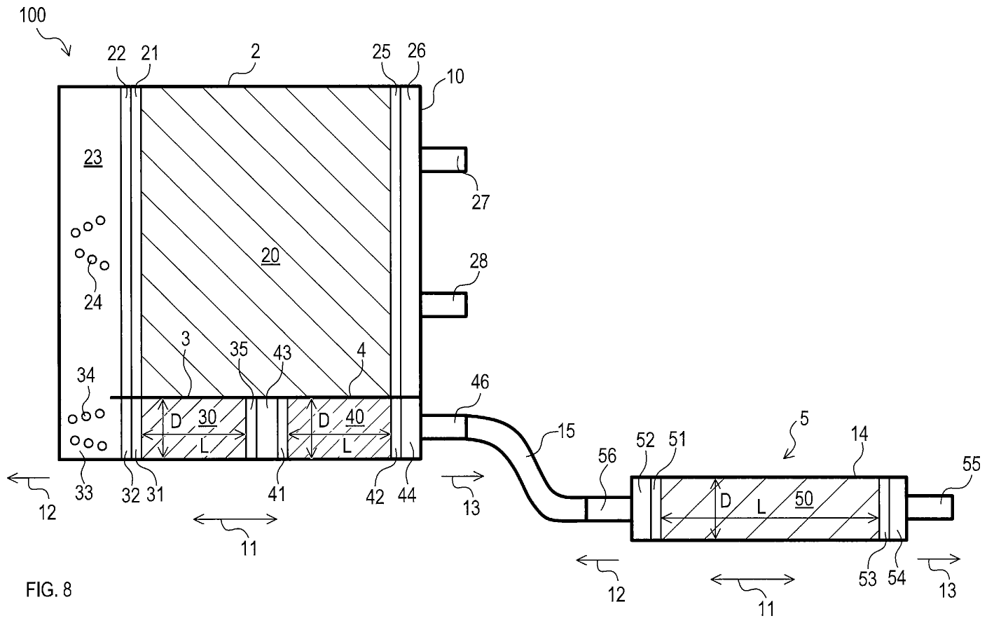

The canister 100 in the second embodiment shown in FIG. 8 has a configuration similar to that of the first embodiment, but is different from the first embodiment in that there are a subsidiary casing 14 and other elements. Hereinafter, the canister 100 will be explained mainly about such differences. The same reference numeral as the first embodiment suggest the same configuration, and the reference of such configuration should be made to the preceding explanations.

Similarly to the first embodiment, the canister 100 comprises the casing 10, the main chamber 2, the first subsidiary chamber 3, the second subsidiary chamber 4, the charge port 27, the purge port 28, an atmosphere port 55, and the absorption layers 20, 30, 40 each comprising activated carbon. The canister 100 further comprises a subsidiary casing 14, a separated subsidiary chamber 5, a hose 15, and a third subsidiary absorption layer 50.

The subsidiary casing 14 is made of a material such as a synthetic resin and houses the separated subsidiary chamber 5. The subsidiary casing 14 is separated from the casing 10. The subsidiary casing 14 includes the atmosphere port 55.

The third subsidiary absorption layer 50, configured similarly to the subsidiary absorption layers in the first embodiment, is disposed in the separated subsidiary chamber 5. A filter 51 is stacked adjacent to the third subsidiary absorption layer 50 on the first side 12. A filter 53 is stacked adjacent to the third subsidiary absorption layer 50 on the second side 13. A connecting port 56 is provided at a first side end of the separated subsidiary chamber 5 on the first side 12. A space 52 is provided between the connecting port 56 and the filter 51. The atmosphere port 55 is provided at a second side end of the separated subsidiary chamber 5 on the second side 13. A space 54 is provided between the atmosphere port 55 and the filter 53.

The second subsidiary chamber 4 is provided with a connecting port 46 in place of the atmosphere port 45. The connecting port 46 is coupled to the connecting port 56 of the subsidiary casing 14 via the hose 15 made of an element such as resin. A gas flows between the second subsidiary chamber 4 and the separated subsidiary chamber 5 via the hose 15. The second side end of the second subsidiary chamber 4 is coupled to the first side end of the separated subsidiary chamber 5.

In the canister 100, the evaporated fuel drawn from the charge port 27 sequentially enters the main chamber 2, the first subsidiary chamber 3, and the second subsidiary chamber 4 in this order. An excess of the evaporated fuel that is not absorbed by the absorption layers in these chambers enters the separated subsidiary chamber 5 through the hose 15 and absorbed by the third subsidiary absorption layer 50. The gas removed of the evaporated fuel is discharged from the atmosphere port 55 that is disposed in the separated subsidiary chamber 5 (in other words, disposed in the subsidiary casing 14).

The purge air is drawn from the atmosphere port 55 by the negative intake air pressure in the engine. The purge air sequentially enters the separated subsidiary chamber 5, the second subsidiary chamber 4, the first subsidiary chamber 3, and the main chamber 2 in this order, and removes the fuel absorbed in the absorption layer of each chamber. The removed fuel is discharged with the purge air through the purge port 28 and supplied to the engine.

### [5. Specified Subsidiary Chamber]

At least one of the first subsidiary chamber 3, the second subsidiary chamber 4, or the separated subsidiary chamber 5 in the canister 100 is configured as a specified subsidiary chamber. A specified absorption layer of the specified subsidiary chamber is configured similarly to that in the first embodiment. In the canister 100 shown in FIG. 8, the separated subsidiary chamber 5 is configured as the specified subsidiary chamber. Nevertheless, the first subsidiary chamber 3 may be configured as the specified subsidiary chamber; the second subsidiary chamber 4 may be configured as the specified subsidiary chamber; or both the first subsidiary chamber 3 and the second subsidiary chamber 4 may be configured as the specified subsidiary chambers. In addition, all of the subsidiary chambers 3, 4, 5 may be configured as the specified subsidiary chambers.

### [6. Volume Ratio]

In the second embodiment, a ratio of a volume of the main absorption layer 20 of the main chamber 2 to a volume of the specified absorption layer (in other words, the third subsidiary absorption layer 50) of the separated subsidiary chamber 5 is also equal to or greater than 5.5 and equal to or less than 10 (see FIG. 8). The volume of the main absorption layer 20 is M, and the volume of the specified absorption layer is Y0. In other words, the volume ratio is M/Y0. Nevertheless, if the first subsidiary chamber 3 or the second subsidiary chamber 4 is the specified subsidiary chamber, then a ratio of the volume of the main absorption layer 20 of the main chamber 2 to a sum of volumes (Y1) of all the specified absorption layers of these chambers may be equal to or greater than 5.5 and equal to or less than 10. In other words, the volume ratio is M/Y1. Also, a ratio of the volume of the main absorption layer 20 to a sum of volumes (Y2) of all the subsidiary absorption layers 30, 40, 50 of the subsidiary chambers 3, 4, 5 may be equal to or greater than 5.5 and equal to or less than 10. In other words, the volume ratio is M/Y2. These volume ratios may also have different values.

### [7. Effect]

(1) According to the aforementioned embodiments, the specified absorption layer of the specified subsidiary chamber includes the specified activated carbon, and therefore improves the capacity to absorb the fuel. Moreover, by setting the L/D of the specified absorption layer to equal to or greater than 2.0 and equal to or less than 7.0, the gas that flows down the specified subsidiary chamber efficiently contacts the specified absorption layer, which helps inhibit an increase in pressure loss. Thus, the absorbed fuel can be more efficiently removed by purging in the specified absorption layer, which can reduce remaining fuel. Therefore, discharge of the fuel to the atmosphere can be reduced in a low-purge vehicle.

(2) The specified absorption layer includes the honeycomb absorbent 6 or the hollow activated carbon 7. This helps further reduce the pressure loss when the gas passes through the specified subsidiary chamber. Thus, the accumulated fuel in the canister can be more efficiently removed by purging and the fuel remaining in the canister can be reduced. Therefore, discharge of the fuel to the atmosphere can be reduced in the low-purge vehicle.

(3) Due to having the vent holes 62, the honeycomb absorbent 6, the hollow activated carbon 7, and the granular activated carbon 8, the specified absorption layer improves the capacity to absorb the evaporated fuel and the capacity to desorb the absorbed evaporated fuel. Therefore, discharge of the fuel to the atmosphere can be reduced in the low-purge vehicle.

(4) When the ratio of the volume of the main absorption layer 20 to the volume of the specified absorption layer is equal to or greater than 5.5 and equal to or less than 10, an amount of fuel remains in the specified subsidiary chamber after purging can be reduced while inhibiting an increase in the pressure loss. Also, when the ratio of the volume of the main absorption layer 20 to the sum of the volumes of all the subsidiary absorption layers is equal to or greater than 5.5 and equal to or less than 10, an amount of fuel remains in each subsidiary chamber after purging can be reduced while inhibiting an increase in the pressure loss. As a result, discharge of the fuel through the atmosphere port can be reduced.

(5) In the canister 100 of the second embodiment, the separated subsidiary chamber 5 provided with the atmosphere port 55 is separated from the casing 10. This enables the canister 100 to be installed in the vehicle in various forms.

### [8. Other Embodiment]

(1) In the first embodiment, the canister 1 may include one subsidiary chamber or three or more subsidiary chambers. In the second embodiment, the casing 10 may include one subsidiary chamber or three or more subsidiary chambers.

(2) Two or more functions of one element in the aforementioned embodiments may be achieved by two or more elements; and one function of one element in the aforementioned embodiments may be achieved by two or more elements. Two or more functions of two or more elements in the aforementioned embodiments may be achieved by one element; one function of two or more elements in the aforementioned embodiments may be achieved by one element. A part of the configuration of the aforementioned embodiments may be omitted. At least a part of the configuration of the aforementioned embodiments may be added to or replaced with another configuration of the aforementioned embodiments.

What is claimed is:

1. A canister configured to accumulate an evaporated fuel generated in a fuel tank of a vehicle, the canister comprising:
a charge port configured to draw the evaporated fuel;
a purge port configured to discharge the evaporated fuel;
an atmosphere port open to atmosphere;
a main chamber where the charge port and the purge port are located, and where a main absorption layer containing activated carbon is disposed; and
at least one subsidiary chamber extending in longitudinal directions,
wherein the longitudinal directions include a first side and a second side,
wherein a subsidiary absorption layer containing activated carbon is disposed in the at least one subsidiary chamber,
wherein a first side end of the at least one subsidiary chamber is coupled to the main chamber or a second side end of a different subsidiary chamber included in the at least one subsidiary chamber,
wherein the at least one subsidiary chamber includes a subsidiary chamber, in a second side end of which the atmosphere port is located,
wherein the at least one subsidiary chamber includes at least one specified subsidiary chamber, in which the subsidiary absorption layer configured as a specified absorption layer is located,
wherein a ratio (L/D) of a length (L) of the specified absorption layer disposed in the at least one specified subsidiary chamber in the longitudinal directions to an equivalent diameter (D) of a cross-section of the specified absorption layer taken orthogonally to the longitudinal directions is equal to or greater than 2.0 and equal to or less than 7.0, and
wherein the activated carbon included in the specified absorption layer is specified activated carbon having butane working capacity (BWC) equal to or greater than 8.0 g/dL and equal to or less than 10.5 g/dL, measured in accordance with D5228 of ASTM Standards.

2. The canister according to claim 1,
wherein a honeycomb absorbent including the specified activated carbon is located in the specified absorption layer,
wherein the honeycomb absorbent is cylindrical and located in the at least one specified subsidiary chamber so as to extend in the longitudinal directions, and
wherein the honeycomb absorbent includes flow passes passing through the honeycomb absorbent in the longitudinal directions.

3. The canister according to claim 1,
wherein the specified absorption layer includes hollow activated carbon,
wherein each hollow activated carbon is a granular member containing the specified activated carbon, and
wherein the hollow activated carbon includes at least one hole passing therethrough.

4. The canister according to claim 1,
wherein the specified absorption layer includes at least one member containing the specified activated carbon, and
wherein the at least one member is configured to improve a capacity to absorb the evaporated fuel and a capacity to desorb the evaporated fuel absorbed in the at least one member by including elongated vent holes.

5. The canister according to claim 2,
wherein the specified absorption layer includes at least one member containing the specified activated carbon, and
wherein the at least one member is configured to improve a capacity to absorb the evaporated fuel and a capacity to desorb the evaporated fuel absorbed in the at least one member by including elongated vent holes.

6. The canister according to claim 3,
wherein the specified absorption layer includes at least one member containing the specified activated carbon, and wherein the at least one member is configured to improve a capacity to absorb the evaporated fuel and a capacity to desorb the evaporated fuel absorbed in the at least one member by including elongated vent holes.

7. The canister according to claim 1,
wherein a ratio of a volume of the main absorption layer of the main chamber to a volume of the specified absorption layer is equal to or greater than 5.5 and equal to or less than 10.

8. The canister according to claim 1,
wherein a ratio of a volume of the main absorption layer of the main chamber to a sum of volumes of the subsidiary absorption layers of all of the at least one subsidiary chamber is equal to or greater than 5.5 and equal to or less than 10.

9. The canister according to claim 7,
wherein a ratio of a volume of the main absorption layer of the main chamber to a sum of volumes of the subsidiary absorption layer of all of the at least one subsidiary chamber is equal to or greater than 5.5 and equal to or less than 10.

10. The canister according to claim 1, further comprising:
a casing comprising the main chamber; and
a subsidiary casing separated from the casing,
wherein the at least one subsidiary chamber includes a plurality of subsidiary chambers,
wherein one subsidiary chamber among the subsidiary chambers is located in the subsidiary casing and rest of the subsidiary chambers are located in the casing,
wherein a first side end of the subsidiary chamber in the subsidiary casing is coupled to a second side end of one of the rest of the subsidiary chambers in the casing via a hose, and
wherein the atmosphere port is provided at a second side end of the subsidiary chamber in the subsidiary casing.
